(19) United States
(12) Patent Application Publication
(10) Pub. No.: US 2006/0081681 A1
(43) Pub. Date: Apr. 20, 2006

(54) Coated diamond particles

(76) Inventor: Noel John Pipkin, Johannesburg North (ZA)

Correspondence Address: Timothy J Keefer;Seyfarth Shaw, 55 E Monroe Street, Chicago, IL, 60603, US

(21) Appl. No.: 10/500,812

(22) PCT Filed: Feb. 13, 2003
(86) PCT No.: PCT/IB03/00465

§ 371 Date: Dec. 30, 2004

(30) Foreign Application Priority Data
Feb. 20, 2002 (ZA) 2002/1428

(51) Int. Cl. A47J 36/02

(52) U.S. Cl. 228/101

(57) ABSTRACT

A method of producing coated diamond particles includes the steps of providing a combination of a transition metal selected from zirconium, hafnium, niobium and tantalum, an activation metal and uncoated diamond particles, and heat treating the combination in a non-oxidizing atmosphere to cause the activation metal to bond to the diamond particles and the transition metal to form a carbide coating on the diamond particles.

### BACKGROUND OF THE INVENTION

This invention relates to coated diamond particles, or grit, and more particularly to coated grit with improved retention and resistance to oxidation in saw blade segments.

Abrasive grit such as diamond and cubic boron nitride particles, are widely used in sawing, drilling, grinding, polishing and other abrasive and cutting applications. In such applications the grit is generally surrounded by a matrix consisting of metals such as Fe, Co, Ni, Cu and alloys thereof (metal bonds). Alternatively, resin (resin bond) or vitreous (vitreous bond) matrices can be used, the choice of matrix being a function of the particular application in which the abrasive is to be used.

Coating diamond with metals consisting of the Group IVa, Va and VIa transition metals (Ti, Zr, Hf, V, Nb, Ta, Cr, Mo and W) or alloys thereof, and/or their respective carbides, has been shown to improve the performance of abrasive grit. In particular, coated diamonds are used extensively in metal bond applications such as sawing and drilling.

The methods for depositing the metal layers on abrasive grit include PVD methods such as described in “Vacuum Deposition of Thin Films” by L. Holland, Chapman and Hall, 1^{st} Edition 1956. Vapour phase CVD methods such as described by M J Hampden-Smith and T T Kodas in “Chemical Vapour Deposition”, Vol. 1, No. 1, 1995 can also be used. Alternative CVD methods involve the mixing of the abrasive grit with oxidised metal powders and heating under inert atmosphere (usually vacuum) such as described by V G Chuprina (Soviet Powder Metallurgy and Metal Ceramics 1992, Vol. 31, No. 7, pp 578-83 and ibid 1992, Vol. 31, No. 8, pp 687-92) or the mixing of abrasive grit and metal powders and heating in a halide (fluorine, chlorine, iodine and bromine or hydrogen compounds thereof) containing inert gas such as described in ASTM B874-96 Standard Specification for Chromium Diffusion Coatings and ASTM B875-96 Standard Specification for Aluminium Diffusion Coatings. These latter processes are often referred to by the term “Pack Cementation”. The use of molten alkaline metal halides such as described by Oki and Tanikawa in Proceedings of 1^{st} International Conference on Molten Salt Chemistry and Technology, p 265, 1983 also offers a means of coating diamonds with the Group IVa, Va and Via transition metals. This latter method uses a similar chemistry to that of the CVD methods.

U.S. Pat. No. 5,024,680 describes a multiple coated diamond grit for improved retention in a tool matrix. The coated grit comprises a first coating layer of a metal carbide of a strong carbide former, preferably chromium, titanium or zirconium, chemically bonded to the diamond, and a second metal coating of an oxidation resistant carbide former, preferably tungsten or tantalum, chemically bonded to the first metal layer. A third metal layer coating of an alloying metal such as nickel may be added. The coated grit is produced by applying a first layer of metal to the grit by metal vapour deposition, followed by applying the second layer metal by chemical vapour deposition. Separate and distinct coating steps are required which is expensive. Further, the second layer or coating is in essentially metallic form. With certain uses of diamond grit, e.g. tools which have free sintered iron matrices, it is preferable that any coating for the grit is a carbide coating and not a metallic coating.

### SUMMARY OF THE INVENTION

According to a first aspect of the invention, a method of producing coated diamond particles includes the steps of providing a combination of a transition metal selected from zirconium, hafnium, niobium and tantalum, an activation metal and uncoated diamond particles, and heat treating the combination in a non-oxidising atmosphere to cause the activation metal to bond to the diamond particles and the transition metal to form a carbide coating on the diamond particles.

In the method of the invention, the activation metal has the function of activating the surfaces of the diamond particles by creating on the particles, it is believed, a suitable number of nucleation growth sites for the transition metal. Thus, the activation metal will generally cover a portion only of the diamond surface to which it is bonded. It is further believed that the provision of sites enables the carbide coating to be formed at temperatures lower than those used in prior art methods.

In the method of the invention, a combination of a transition metal, an activation metal and uncoated diamond particles is heat treated. The transition metal may be in particulate form in the combination or it may be in the form of a mesh, layer or sheet, for example, as a canister enclosing the uncoated diamond particles and activation metal. The activation metal may also be in particulate form or as a sheet, layer or mesh and may also be in the form of an alloy with another metal.

In one particular form of the invention, the combination comprises a particulate mass of the transition metal, in particulate form, and the activation metal, also in particulate form, and the uncoated diamond particles. Generally, the particles are mixed to form a particulate mass.

The heat treatment preferably takes place in the presence of a gaseous halide, particularly gaseous chloride. The gaseous halide can be produced in situ from a halide which volatilises under the conditions of heat treatment. An example of a suitable halide which volatilises is ammonium halide, e.g. ammonium chloride. The gaseous halide assists in forming the activation metal bond with the diamond and the carbide formation with the transition metal.

The heat treatment will generally take place at a temperature of at least 800° C. and preferably at a temperature of 850° C., The period of heat treatment will vary according to the extent of carbide coating desired and will generally be from 1 to 4 hours.

The heat treatment takes place in a non-oxidising atmosphere. The non-oxidising atmosphere may be an inert gas such as argon, a reducing gas such as hydrogen or a combination thereof. For example, when the method takes place in the presence of an ammonium halide, hydrogen is generated which creates a reducing atmosphere.

The transition metal carbide coats the individual diamond particles completely enclosing the particle. The coating is essentially a carbide coating. The outer surface of the coating may have a minor amount of a transition metal, in metal form, but essentially the coating is a carbide coating.

Examples of suitable activation metals are titanium, vanadium and chromium. The preferred activation metal is chromium.

The preferred transition metal is tantalum.

The amount of activation metal relative to the transition metal will be small and generally no more than 2% by weight, preferably no more than 0.2% by weight, of the activation metal and transition metal.

The coated diamond produced by the method described above is believed to be new and forms another aspect of the invention. Thus, according to this aspect of the invention, there is provided a coated diamond particle wherein the coating comprises an activation metal bonded to the diamond surface and a layer, completely enclosing the diamond particle, of a carbide of a transition metal selected from zirconium, hafnium, niobium and tantalum. The activation metal, as mentioned above, will generally cover a portion only of the diamond surface to which it is bonded. Such portion may be a continuous area or a plurality of isolated spots.

The diamond particles are preferably those suitable for saw applications and may be blocky and strong in nature. Such particles will generally have cube {100} facets, and/or octahedra {111} facets. Such particles will generally have a particle size of at least 170 μm.

The coated diamond particles have particular application in saw applications where the matrix is an iron or ferrous bond matrix.

### DESCRIPTION OF EMBODIMENTS

The invention will now be illustrated by the following examples.

### EXAMPLE 1

5 gm of 595-420 micron Element Six SDB1100 diamond grit was mixed with 20 gm of tantalum powder and 0.024 gm of ammonium chloride (NH₄Cl). The mixture was encapsulated in nickel and heated to 900° C. in an argon atmosphere and held at this temperature for four hours before cooling to ambient temperature.

The grit was recovered from the mixture by sieving and it was found that the diamond was totally uncoated.

### EXAMPLE 2

The same procedure as described in Example 1 was followed but with 0.01 wt % chromium powder mixed with the tantalum powder.

On recovery of the diamond grit after, the heating cycle, it was noted that all of the diamond particles were partially coated with metal which was shown by X-ray diffraction methods to be tantalum carbide.

It was noted that preferential growth of the tantalum carbide occurred on the {100} or cube crystal facets.

### EXAMPLE 3

The same procedure as described in Example 2 was followed but a suite of samples was prepared containing 0.05 wt %, 0.10 wt %, 0.20 wt %, 0.50 wt %, 1.0 wt % and 2.0 wt % chromium powder mixed with the tantalum powder.

On recovery of the diamond grit, after the heating cycle, it was noted that all of the diamond particles were coated with a coherent dense layer of metal which was shown by X-ray diffraction methods to be tantalum carbide.

It was a further feature of these coatings that the thickness of the chromium carbide layers increased as the chromium concentration in the starting mixtures increased to the highest level of chromium (2 wt %). At these higher chromium levels there is a tendency for the coating to crack and spall off.

It is thus preferred that as little chromium as is necessary to induce the deposition of a coherent tantalum carbide layer is used.

### EXAMPLE 4

The effect of temperature and time on the coating rate was examined using tantalum powder containing 0.1 wt % chromium powder.

The following table shows the temperatures and heating times used and the mass of coating measured. The coating mass is the average mass of the coating expressed as a percentage of the mass of the coated particles.

| Temperature | Time | Coating Mass |
|---|---|---|
| (° C.) | (hrs) | (wt %) |
| 900 | 4 | 3.12 |
| 900 | 1 | 2.34 |
| 850 | 4 | 2.33 |
| 800 | 4 | 1.99 |

On recovery of the diamond grit, after the heating cycles, it was noted that in all cases the diamond particles were coated with a coherent dense layer which was shown by X-ray diffraction methods to be tantalum carbide.

### EXAMPLE 5

6 gm of 595-420 micron Element Six SDB 100 diamond grit was mixed with 8 gm of niobium powder and 0.024 gm of ammonium chloride (NH₄Cl). The mixture was encapsulated in nickel and heated to 850° C. in an argon atmosphere and held at this temperature for four hours before cooling to ambient temperature.

The grit was recovered from the mixture by sieving and it was found that the diamond was only sparsely coated. It was noted that the {100} cube facets coated more readily than the {111} octahedral facets.

### EXAMPLE 6

The same procedure as described in Example 5 was followed but a suite of samples was prepared containing 0.01 wt % Cr, 0.05 wt %, 0.01 wt % and 0.20 wt % chromium powder mixed with the niobium powder.

On recovery of the diamond grits those coated using the 0.01 and 0.05 wt % showed incoherent coating whereas the two high chromium additions resulted in grits which had totally coherent coatings. The following table lists the coating data for these grits.

| Chromium addition | Coating mass |
|---|---|
| (wt %) | (wt %) |
| 0.01 | 0.68 |
| 0.05 | 0.72 |
| 0.1 | 3.66 |
| 0.2 | 2.87 |

### EXAMPLE 7

6 gm of 595-420 micron Element Six SDB1100 diamond grit was mixed with 10 gm of tungsten containing 0.08 wt % chromium and 0.024 gm of ammonium chloride (NH₄Cl). The mixture encapsulated in tantalum and heated to 900° C. in an argon atmosphere and held at this temperature for four hours before cooling to ambient temperature.

On recovery of the grit it was found that the diamond cube facets were coated and the octahedral facets partially coated with tantalum carbide.

This result can be compared with Example 1 and shows that the chromium present in the tungsten powder has enhanced the nucleation of the tantalum carbide on the diamond grit.

1. A method of producing coated diamond particles includes the steps of providing a combination of a transition metal selected from zirconium, hafnium, niobium and tantalum, an activation metal and uncoated diamond particles, and heat treating the combination in a non-oxidising atmosphere to cause the activation metal to bond to the diamond particles and the transition metal to form a carbide coating on the diamond particles.

2. A method according to claim 1 wherein the transition metal is in particulate form.

3. A method according to claim 1 or claim 2 wherein the transition metal is in mesh, sheet or layer form.

4. A method according to any one of claims 1 to 3 wherein the activation metal is in particulate form.

5. A method according to claim 1 wherein the transition metal and activation metal are in particulate form and the combination is a particulate mass.

6. A method according to any of the preceding claims wherein the activation metal is in an amount of no more than 2% by weight of the transition metal and activation metal.

7. A method according to any one of claims 1 to 5 wherein the activation metal is present in an amount of no more than 0.2% by weight of the transition metal and activation metal.

8. A method according to any one of the preceding claims wherein the heat treatment takes place in the presence of a gaseous halide.

9. A method according to claim 8 wherein the gaseous halide is gaseous chloride.

10. A method according to claim 8 or claim 9 wherein the gaseous halide is produced in situ from a halide which volatilises under the conditions of heat treatment.

11. A method according to claim 10 wherein the halide which volatilises under the conditions of heat treatment is an ammonium halide.

12. A method according to claim 11 wherein the ammonium halide is ammonium chloride.

13. A method according to any one of the preceding claims wherein the heat treatment takes place at a temperature of at least 800° C.

14. A method according to any one of the preceding claims wherein the period of heat treatment is one to four hours.

15. A method according to any one of the preceding claims wherein the activation metal is selected from titanium, vanadium and chromium.

16. A method according to claim 15 wherein the activation metal is chromium.

17. A method according to any one of the preceding claims wherein the transition metal is tantalum.

18. A method according to any one of the preceding claims wherein the activation metal bonded to the diamond covers a portion only of the surface of the diamond.

19. A coated diamond particle wherein the coating comprises an activation metal bonded to the diamond surface and a layer, completely enclosing the diamond particle, of a carbide of a transition metal selected from zirconium, hafnium, niobium and tantalum.

20. A coated diamond particle according to claim 19 wherein the activation metal covers a portion only of the diamond surface.

21. A coated diamond according to claim 19 or claim 20 wherein the transition metal is tantalum.

22. A coated diamond according to any one of claims 19 to 21 wherein the activation metal is selected from titanium, vanadium and chromium.

23. A coated diamond according to claim 22 wherein the activation metal is chromium.

24. A method of producing a metal coated diamond particle according to claim 1 and substantially as herein described with reference to any one of Examples 2 to 4, 6 and 7.

25. A coated diamond according to claim 16 substantially as herein described with reference to any one of Examples 2 to 4, 6 and 7.
